(19) United States
(12) Patent Application Publication
(10) Pub. No.: US 2022/0064758 A1
(43) Pub. Date: Mar. 3, 2022

(54) ALUMINUM RECOVERY METHOD

(71) Applicant: COMPANHIA BRASILEIRA DE ALUMÍNIO, São Paulo (BR)

(72) Inventor: Roberto Seno Junior, Sorocaba (BR)

(73) Assignee: COMPANHIA BRASILEIRA DE ALUMÍNIO, São Paulo (BR)

(21) Appl. No.: 17/418,760

(22) PCT Filed: Dec. 26, 2019
(86) PCT No.: PCT/BR2019/050563

§ 371 Date: Jun. 25, 2021

(30) Foreign Application Priority Data
Dec. 27, 2018 (BR) 102018077286 4
Nov. 28, 2019 (BR) 102019025163 8

(51) Int. Cl. C22B 21/00; C22B 7/00; B29B 17/02; B33Y 40/00; B22F 10/73

(52) U.S. Cl. CPC C22B 21/0023; C22B 7/006; B29B 2017/0289; B33Y 40/00; B22F 10/73; B29B 17/02

(57) ABSTRACT

A process for the recovery of aluminum, or recycling process, is described, which is based on separating the aluminum contained in aseptic carton packs (1), flexible packs (2) and residual aluminum alloy powder (3) used in manufacturing additive, through the selective dissolution of aluminum in a solution known as Bayer liquor and/or caustic soda, with sodium aluminate (liquid) and hydrogen gas (H₂, gaseous) products. Both products can be used in an alumina refinery, the sodium aluminate is used for the production of aluminum hydroxide and the hydrogen can be used as fuel for boilers, furnaces or similar.

The present invention relates to aluminum recovery processes and, more particularly, to the recycling of aluminum present in aseptic carton packs and flexible packs, after processes of mechanical separation of paper and cleaning. It also refers to the recovery of aluminum from aluminum powder from the production of parts by additive manufacturing, for example, 3D printing.

### STATE OF THE ART

As is well known in this area, multilayer packaging laminated with aluminum foil has promoted great gains in reducing the carbon footprint of companies as it has reduced the weight of packaging and increased the protection of food from agents such as light, moisture, and oxygen. Nowadays, the challenge for industries that produce laminated multilayers is in post-consumption, both to carry out reverse logistics and to recycle packaging.

Among these packages there is, for example, aseptic carton packs (as shown in FIG. 1A), composed of paper, polyethylene and aluminum. There are also flexible packages, and among the most varied we can find aluminum, polyethylene, polypropylene, PET, biaxially oriented polyamide (BOPA), polyester, copolymers, bioriented polyethylene (BOPP) in its composition.

Aluminum represents about 5% of the aseptic carton pack.

There are already processes for separating the paper layer from polyethylene films through a mechanical separator, known as Hidrapulper. The difficulty lies in separating the aluminum present in this by-product of polyethylene and aluminum, known as PolyAlu, because there is an adhesion between the polyethylene and the aluminum.

For the separation of PolyAlu there are chemical and thermal processes. EET/TSL, a plant located in the city of Piracicaba features pyrolysis technology followed by thermal plasma and holds a process that generates byproducts of paraffin compounds and aluminum flakes. This plant is currently closed and it is a plant that does not have a self-sustaining process, as it uses electricity.

There are other separation processes known, such as: that of the company Bioware, which developed a pyrolysis technology in cooperation with the applicant, as described in document BR 10 2017 004348-7, published on Oct. 30, 2018, and concerning a process for the recovery by pyrolysis of aluminum and polymers present in aseptic carton packages; that of the company Saperatec, which presents a chemical separation process in document US 2017/0080603 A1; that of the company Stora Enso, a Finnish company that inaugurated in Spain in 2011 a pyrolysis plant (operating at around 400° C.) for recycling aluminum and polyethylene from cartons (Marques, 2013); that of the company Enval, which presents a pyrolysis technology of plastic and aluminum laminates through microwaves to induce pyrolysis (temperatures higher than 1000° C.) and generate valuable oils (Source: Enval's website); that of the company Pyral, which has developed a patented pyrolysis technology with a temperature around 500° C. (Source: Pyral's website); and that of Maim Engineering, an Italian company, which presents a thermochemical pyrolysis technology through a wet and slow process and catalyzed by RH₂INO, for low-cost energy generation (Source: Maim Engineering website); among others.

The products obtained after pyrolysis are compounds or other organic compounds, in addition to aluminum contaminated with polyethylene. In these separation processes it is possible to see that the interest lies in the recovery of the polymers present, which already have a consumer market, making the packaging plastic renewable.

The recycling of aluminum, on the other hand, presents technological and economic barriers, as it is difficult to be remelted. The aluminum coining from pyrolysis is very fine and presents difficulties for compaction. In remelting furnaces (traditional recycling) aluminum oxidation occurs, with increased slag generation. The residual polyethylene from the separation process has the same slag generation effect. The purity of the final aluminum obtained is usually low and the energy cost to separate residues from pyrolysis is high. These barriers make it impossible to recycle aluminum in smelters.

Thus, the search for a technologically sound, economically viable, and ecologically responsible process for recovering aluminum from aseptic cartons and flexible packaging after mechanical separation from paper persists in the art.

In addition, the studies on additive manufacturing of parts with complex and differentiated geometries have grown a lot in the last years, which has generated a search for more efficient methods to increase quality and reduce costs. Thus, the 3D printing process is a method that is studied for this application and there are already applications with aluminum alloys.

In additive manufacturing, aluminum alloys are being studied to create new products that require low density and good mechanical resistance. There are many techniques for part production by rapid prototyping, including powder-based processing, such as selective laser sintering (SLS) and selective laser fusion (SLM), in which a layer is deposited on a bed and the laser selectively sinters, according to the design of the piece, layer by layer inside a chamber, until the object is built and cooled.

After processing, part of the powder that was used in these processes ends up losing its physical characteristics, and may condense and remain agglomerated, which causes defects in the part and loss of mechanical properties. Studies show that when using recycled powder to process new parts, losses of mechanical properties occur. Therefore, the reuse of the powder after the prototyping of a part is made only of part of the powder. The part that was partially hit by the laser is discarded.

Currently there are no routes to recycle this material and this causes it to be disposed of in an incorrect manner. Thus, thinking about the near future, where additive manufacturing of parts with aluminum alloys is carried out, this powder should also be recycled.

### PURPOSES OF THE INVENTION

A primary object of the invention is an alkaline hydrometallurgical process using Bayer process solution (sodium aluminate) for converting aluminum from recycled aseptic carton or flexible packaging previously processed via mechanical, chemical or thermal separation into sodium aluminate with hydrogen generation.

A process for recycling aluminum powder from additive manufacturing processes constitutes a further object of the invention.

### SYNTHESIS OF THE INVENTION

These and other objectives are achieved from the process of aluminum recovery, from a recycled material containing aluminum, such as: aseptic carton packages, flexible packages, aluminum powders, or similar, comprising the steps of: dissolving, via alkaline dissolution, the aluminum-containing raw material in Bayer liquor, generating sodium aluminate and hydrogen gas; and submitting the sodium aluminate to Bayer's process for producing alumina and then aluminum. Furthermore, the process comprises the additional step of using the hydrogen gas produced in the alkaline dissolution step as fuel in the combustion units of the alumina refinery.

The alkaline dissolution comprises the reaction, in a reactor, of the post-treated raw material with Bayer liquor, said Bayer liquor being added in concentrations from 100 g/l to 1,000 g/l, on a Na₂CO₃ basis. In another alternative, alkaline dissolution comprises the reaction of the post-treated raw material with a mixture comprising Bayer liquor and caustic soda, said caustic soda being added in an amount of up to 50% by weight as a correction to the concentration of the sodium aluminate solution.

After the alkaline dissolution step, the additional step of carrying out a liquid/solid separation is foreseen in order to separate the sodium aluminate (liquid) from the polymeric residues (solids). Solid polymeric waste is subjected to a cleaning process and subsequent recycling. The process of cleaning the solid waste includes washing the solid waste with water to eliminate the residual sodium aluminate, then drying the solid waste and further processing the polymer, via extrusion, pressing, injection, among others.

Finally, the process of the invention further provides for the preparation of the aluminum-containing raw material prior to alkaline dissolution. Thus, when the recycled material containing aluminum is obtained from aseptic carton packages, the cleaning process comprises the steps of: removing the paper, preferably via hydrapulper, generating an aluminum-polymer laminated by-product (PolyAlu); and processing the by-product (PolyAlu), from: a cleaning procedure, to generate a feedstock suitable for the alkaline dissolution step; or a pyrolysis process followed by a char removal process, to generate a feedstock suitable for the alkaline dissolution step; or a chemical separation process, to generate a feedstock suitable for the alkaline dissolution step. When the recycled material containing aluminum is obtained from flexible packaging, the process comprises the steps of: subjecting the flexible packaging to a pyrolysis process followed by a charcoal removal process, to generate a raw material suitable for the alkaline dissolution step; or grinding the flexible packaging, or the flexible packaging chips, to generate a raw material suitable for the alkaline dissolution step. Finally, and when the recycled material containing aluminum is aluminum powder, alkaline dissolution proceeds directly, without the need for any previous treatment. The process of the invention provides that the alkaline dissolution can employ one, or a combination, of the above raw materials.

More particularly, the present invention proposes new routes for recycling the aluminum contained in the material known as PolyAlu from recycled packaging generated after mechanical, thermal or chemical separation of the polymer layers, even if it still has a contamination of polymers or paraffinic compounds. The invention also proposes this recycling route for recycling the aluminum contained in flexible packaging and also the aluminum present in the powder after processing via additive manufacturing.

### BRIEF DESCRIPTION OF FIGURES

The present invention will be better understood from the detailed description of its preferred ways of realization, which take as reference the attached figures, brought as illustrative and not limitative of the invention, in which:

FIGS. 1A and 1B illustrate two possible sources of recycled aluminum suitable for use in the process of the invention, and in particular FIG. 1A shows a sectional view of the layers present in an aseptic carton pack, or long life pack, while the FIG. 1B illustrates the layers that define an aseptic carton pack, or long-life pack;

FIGS. 2A and 2B schematically illustrate the process of the present invention;

FIG. 3 is a schematic representation of the composition of the Bayer liquor;

FIG. 4 is a flow diagram of the production process, according to the invention, in which the raw material containing aluminum is dissolved via alkaline dissolution with Bayer liquor;

FIG. 5 is a flow chart of the production process, according to the invention, in which the raw material containing aluminum is dissolved via alkaline dissolution with Bayer liquor and NaOH;

FIG. 6 is a schematic illustration of the PolyAlu cleaning process, according to Step 1 of the process;

FIG. 8 is a flow chart of the solid-liquid separation process, according to Step 3;

FIG. 8 is a flow chart of the cleaning process, according to Step 3 of the invention process;

FIG. 9 is the FTIR analysis graph of PolyAlu after the cleaning process;

FIG. 10 is the DSC analysis graph of PolyAlu after the cleaning process;

FIG. 11 is the graph of the aluminum dissolution temperature profile;

12 is the FTIR analysis graph of the polymer from PolyAlu after the aluminum dissolution process;

FIG. 13 is the DSC analysis graph of the polymer from PolyAlu after the aluminum dissolution process;

FIG. 14 is the comparative graph of DSC of PolyAlu after the cleaning process and the polymer from PolyAlu after the aluminum dissolution process;

FIGS. 15A and 15B are, respectively, photos of the PolyAlu before and after the alkaline dissolution process;

FIG. 15C is a photo of the polymer after the dissolution process, hot compacted (melt) and milled;

FIG. 15D is a photo of the extruded polymer;

FIGS. 15E and 15F are photos of the polymer after injection of tensile specimens into a mold; and

FIG. 16 is a graph of the stress and strain of the polymer after the dissolution process.

FIG. 17 is a photo of the experiment with agitation and temperature control;

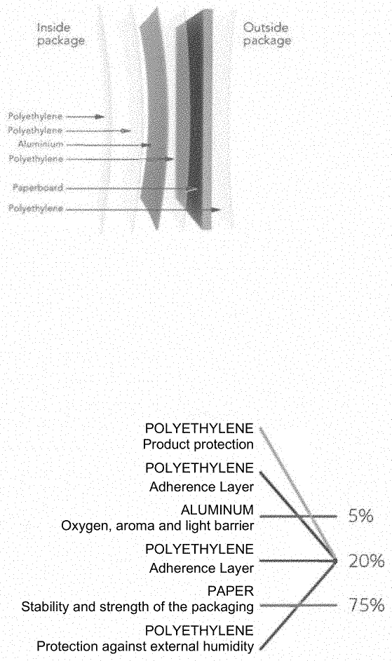

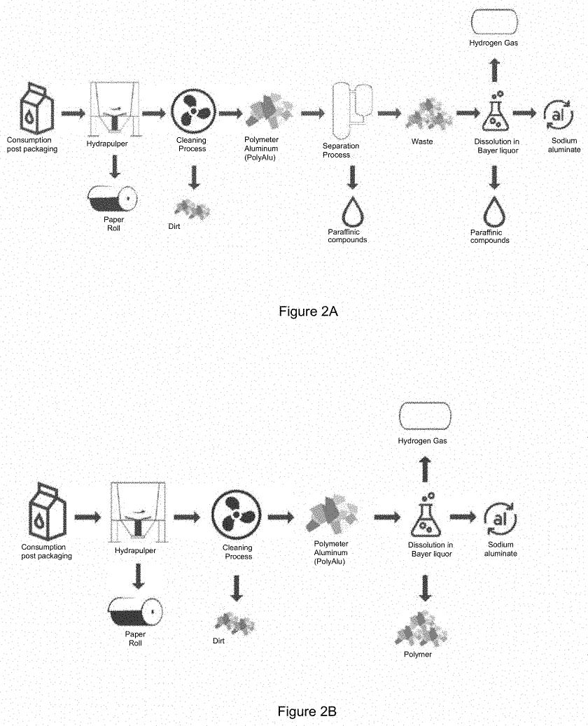

### DETAILED DESCRIPTION OF THE INVENTION

As anticipated, the present invention comprises a process for recycling aluminum, from the recycling of aseptic carton packs. The invention also comprises a process for recycling aluminum from flexible packaging and aluminum powder from additive manufacturing.

More particularly, the invention comprises a hydrometallurgical process for the conversion of aluminum to sodium aluminate with hydrogen gas generation, allowing these to be incorporated into the Bayer process for alumina production. This process presents as products: sodium aluminate, which is also generated in the Bayer process, for the production of alumina; and hydrogen, a gas that presents great calorific power and its burning does not generate greenhouse effect gases. Hydrogen can be used as a fuel in the refinery if it is mixed with natural gas or combustion air in the calciners or boilers. The invention is still apt to generate gains for the refinery in reduced bauxite and NaOH consumption, lower waste generation, and higher energy efficiency.

The Bayer process is known as a technology for producing aluminum oxide (Al₂O₃), also known as alumina, which is the raw material for aluminum production. This process can be briefly described as: the digestion of bauxite, an ore containing alumina, through the addition of caustic soda (NaOH) and a system controlled by temperature and pressure. The attack of alumina by soda can be defined by the reaction:

Al₂O₃(s)+2NaOH→2NaAlO₂(sol)+H₂O(liq)

This attack forms NaAlO₂ (l) sodium aluminate. The other minerals present in bauxite are inert to the process and remain in solid form, being discarded in the form of “red mud”, the residue of the Bayer process. The solution, known as Bayer liquor, with the presence of sodium aluminate, proceeds to precipitate aluminum hydroxide (Al₂O₃.3H₂O), also known as hydrate, according to the equation below:

2NaAlO₂(sol)+4H₂O(l)+seeds→Al₂O₃.3H₂O(s)+2NaOH(sol)

The liquor returns to the digestion process and the hydrate goes to calcination, where the operation reaches temperatures around 1000° C., removing the molecules of crystallization water. The stage is represented in the equation:

Al₂O₃.3H₂O(s)→Al₂O₃(s)+3H₂O(v)

The alumina produced goes on to the electrolytic reduction process for the production of primary aluminum, known as Hall-Heroúlt.

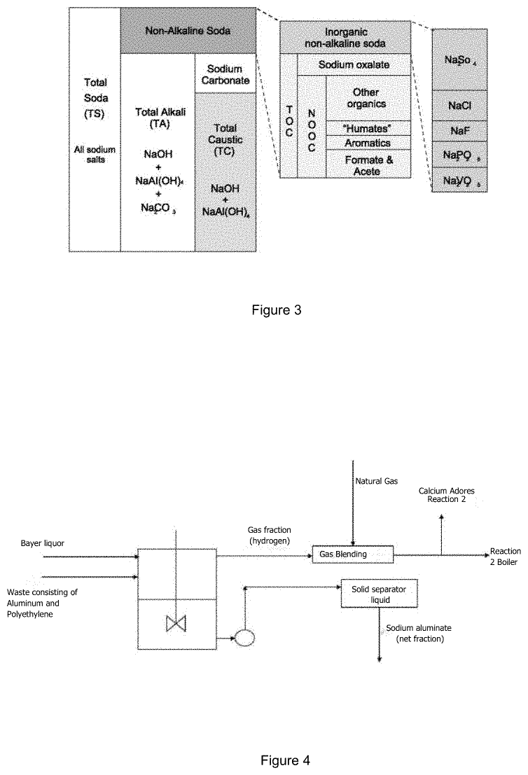

In turn, Bayer liqueur has a complex composition. But in general, it is possible to state that it is composed of: sodium aluminate, other sodium compounds and an excess of caustic soda, as shown in FIG. 3 (Source: Hydrometallurgy—International Journal from Elsevier).

Thus, and returning to the invention itself, the invention consists of incorporating reactions 1 and 2 (below) in the alumina production process, allowing the recycling of aluminum from the materials mentioned in the first paragraph of the detailed description of the invention. Reaction 1 dissolves the aluminum contained in the materials, generating hydrogen and sodium aluminate. The hydrogen is harnessed through reaction 2 allowing energy gain and fuel consumption reduction at the refinery. The aluminate generated is used in the Bayer process, just like the sodium aluminate regularly generated in the refinery. Thus, there is a reduction in the consumption of bauxite and NaOH and also less generation of waste, known as “red mud”. The remaining polymers from the initial materials are then separated, washed and dried for later recycling.

### Reaction 1: Reaction of Metallic Aluminum in Caustic Solution (Sodium Aluminate and Sodium Hydroxide) for the Production of Hydrogen

The following reaction is already a known reaction for the generation of sodium and hydrogen aluminate:

NaAlO₂(l)+2NaOH(aq)+2Al(s)+2H₂O(aq)→3NaAlO₂(aq)+3H₂(g) (Reação 1)
energy release: ΔH=−1133.2 kJ/mol

The reaction is exothermic and releases a lot of heat, besides promoting the dissolution of the aluminate in the solution and releasing hydrogen gas during the process.

There are many studies on the generation of hydrogen gas from aluminum. For example, the Universidade Federal do Rio Grande do Sul, UFRGS, published in Scielo a study of the production of hydrogen from the reaction of aluminum and water in the presence of NaOH or KOH (Porciúncula, et al., 2011) which conclude that this process generates a high purity hydrogen gas.

### Reaction 2: Hydrogen Combustion

The combustion of hydrogen gas can be described by the following reaction:

2H₂(g)+O₂(g)→2H₂O(l)+572 kJ(286 kJ/mol) (Reaction 2)

Among the fuels used, this one has the highest amount of energy per unit mass. For example, approximately three times the calorific value of natural gas. The difficulty of its competitiveness is in production, since hydrogen is not a primary fuel and, for its generation, it is necessary to extract it from the association of this hydrogen from its source of origin.

### Description of the Invention Stages

The use of reactions 1 and 2 above, in the Bayer process, follows the proposed route, as illustrated in FIGS. 4 and 5, consisting of the alkaline dissolution of the aluminum present in the raw material in sodium aluminate and hydrogen. The raw material that comprises aluminum can come from different origins: (1) PolyAlu after hydrapulper; (1.a) PolyAlu after the cleaning process; (1.b) PolyAlu after pyrolysis; (1.c) PolyAlu after chemical separation; (2) Flexible packaging; (2.a) Flexible packaging after pyrolysis; or (3) 3D post-printing aluminum powder. At the end of this route, there is the separation of the polymer, which goes through the cleaning and later recycling stage.

The production process, according to the invention (see FIG. 4), can be divided into 4 stages, namely:
Step 1—preparation of the raw material;
Step 2—alkaline dissolution of aluminum;
Step 3—separation and cleaning of the polymer after alkaline dissolution; and
Step 4—polymer recycling (except for 3D post-printing aluminum powder).

### Step 1—Preparation of the Raw Material

### Raw Material (1) PolyAlu After Hydrapulper

The post-consumer aseptic packaging is processed in recyclers, where the paper is reused and the PolyAlu residue is generated and baled. The PolyAlu paper separation system consists of mixing the packages with water in a device called a hidrapulper.

### Raw Material (1.a) PolyAlu After the Cleaning Process

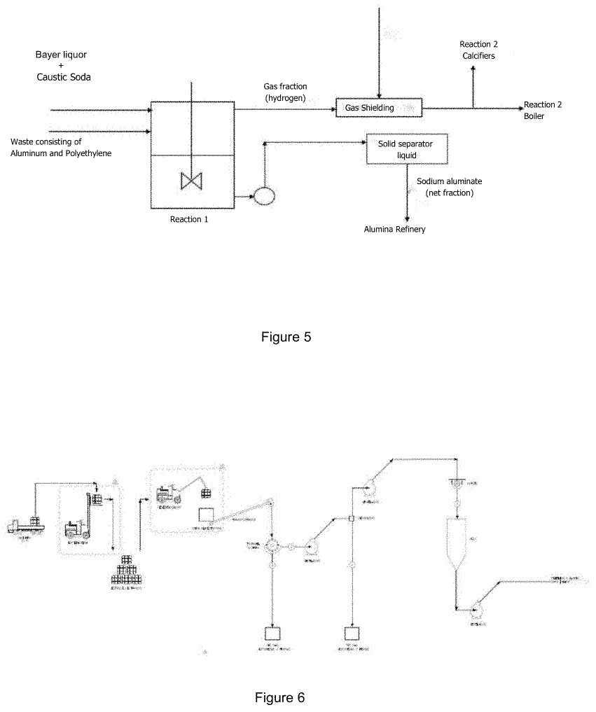

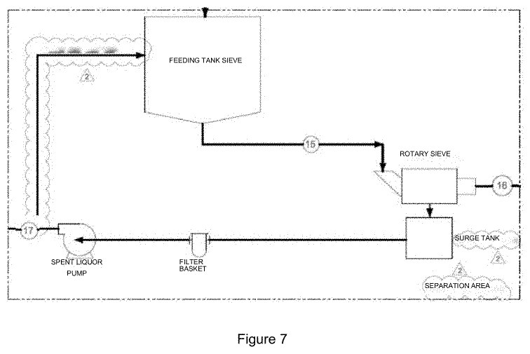

For the generation of the raw material (1.a), PolyAlu proceeds to the cleaning process, as shown in FIG. 6.

The metal strips that hold the bales are removed manually. A mini loader with grapples, or other capable equipment, performs the “unpacking” of the material and feeds the box that directs it to a separator, with the function of segregating the fibers and later sending the material to a sequence of fans that perform the pneumatic transport. A fan is placed between the fans, which separates unwanted residues of greater weight.

### Raw Material (1.b) PolyAlu After Pyrolysis & (2.a) Flexible Packaging After Pyrolysis

The formation of raw materials (1.b) and (2.a) takes place in pyrolysis reactors and subsequently proceeds to a coal removal step. Coal is an undesirable constituent, as it contaminates Bayer liquor in the alkaline dissolution stage.

Pyrolysis is not a necessary step in the process of alkaline dissolution of aluminum from PolyAlu and flexible packaging, but it is an alternative to the difficulty of recyclers to separate this material from metalized plastic packaging.

Raw material (1.c) PolyAlu After Chemical Separation

The formation of the raw material (1.c) occurs in tanks separating the layers through chemical reaction followed by washing.

Chemical separation is not a necessary step in the alkaline aluminum dissolution process from PolyAlu, but it is an alternative to exposing the aluminum layer. A problem faced by this process is the waste generated.

### Raw Material (2) Flexible Packaging

Flexible packaging (2) suitable for the process of the invention comprises: plastic packaging laminated with multilayer films of different structures and an aluminum layer, usually used in the food industry, personal hygiene, chemical industry, cosmetics and pharmaceuticals.

The chips from the flexible packaging production process (2) do not need to go through the cleaning step, but they must be reduced in size in mills to improve the reaction of the raw material (2b) thus generated. Flexible recycled packaging, on the other hand, requires a previous cleaning step and is reduced in size.

### Raw Material (3) Aluminum Powder 3D Post Printing

Aluminum powder does not need to be pre-treated.

### Step 2—Alkaline Dissolution Process of Aluminum

Reaction 1 occurs after adding the material in a reactor together with liquor from the Bayer process (sodium aluminate) in concentrations of 100 g/l to 1,000 g/l in the Na₂CO₃ base, according to the flowchart shown in FIG. 4. Alternatively, the alkaline dissolution process can occur by feeding, in said reactor, the material (raw material 1a, 1b, 1c, 2, 2a or 3) containing aluminum with a mixture between caustic soda and Bayer liquor, said caustic soda being added in an amount of up to 50% by weight, according to the flowchart shown in FIG. 5.

The reactor is fed with one of the raw materials described in step 1, with batch fans so that it is possible to vary the aluminum supply from different sources. In plants with only one material source, it is possible to carry out the process continuously.

The location of the reactor should preferably be close to the consumer of the hydrogen gas generated. In boilers and calciners of refineries supplied with natural gas it is possible to blend the two gases and reuse the energy generated.

In alumina refineries that do not use natural gas, it is possible to bum hydrogen gas mixed with combustion air in boilers, calciners, similar systems, or store them for later sale. Both processes require the compressor to help remove the gas generated in the reactor and perform compression.

### Step 3—Process of Separation and Cleaning of the Polymer After Dissolution

### Separation Process of Polymer and Sodium Aluminate

To take advantage of the sodium aluminate generated in the reactor, the solid-liquid separation step, described in FIG. 7, is necessary. The liquid is used in the Bayer process and the solid goes on to the cleaning stage.

### Process of Cleaning the Polymer After Alkaline Dissolution

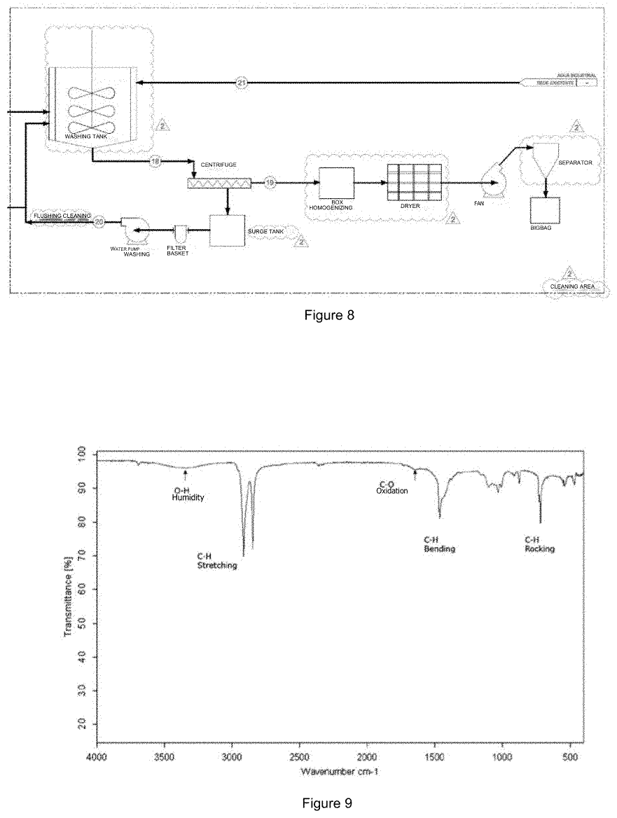

The polymer after the alkaline dissolution step remains with the characteristics preserved, however, for recycling to be possible it is necessary to reduce the residual sodium aluminate content through the water cleaning step, as shown in FIG. 8.

### Step 4—Polymer Recycling

The solid has its moisture reduced in the drying step and is stored in big-bags for later densification and use, as in extrusions, for example. The polymer generated has properties close to the original material and can be used to produce different materials.

### Materials, Methods and Results

Based on studies carried out for the production of sodium and hydrogen aluminate from the materials mentioned above and knowledge of the refinery process, laboratory tests were carried out to confirm the generation of these products.

### Characterization of Bayer Liquor

Analyses were performed by titulometry, using as reference the NBR 15944 standard of May 2011, to determine the caustic concentration of the solution, being the sum of the sodium hydroxide and aluminate components (NaOH e Na₂AlO₂),expressed as TC (Total Caustic), the concentration of alumina, expressed in the form of aluminum oxide (Al₂O₃), and the concentration of sodium carbonate, expressed as Na₂CO₃. All of these terminologies are typical of the Bayer process and facilitate the assessment of the impacts of this process.

An ion chromatography analysis was also carried out to determine the concentration of sodium chlorides, fluorides, sulfates and oxalates. The analyzes are available in table 1. This result shows the composition of Bayer liquor to confirm the increase in dissolved alumina content.

TABLE 1
Composition of Bayer liquor

| Total | | Na₂CO₃ | NaC₂O₄ | NaCl | NaF | Na₂SO₄ | Density | Viscosity |
|---|---|---|---|---|---|---|---|---|
| (g/L) | CausticAl₂O₃ (g/L) | (g/L) | (g/L) | (g/L) | (g/L) | (g/L) | (g/L) | (cP) |
| 228.3 | 100.2 | 74.6 | 4.59 | 6.56 | 0.81 | 3.98 | 1.13 | 48 |

### Characterization of PolyAlu

Analyses of the aseptic carton packaging materials post-consumer and post-cleaning process, the post-pyrolysis PolyAlu and the post-3D printing aluminum powder to determine the percentage of aluminum were performed by a Panalytical X-Ray Fluorescence equipment, model Axios Minerals, for qualitative and quantitative assays, and the Spectra Evaluation program was used to analyze the scan.

To determine the properties of the polyethylene, a Differential Scanning Calorimetry (DSC) was performed. The analyzes were carried out in an inert atmosphere with a purge gas flow of 50 ml/min of argon and a protector of 100 ml/min of argon. Heating was carried out from 25° C. to 600° C. at a rate of 10° C./min. Empty alumina crucibles were used as a reference.

To determine the moisture content of the material, samples, already weighed, were placed in an oven at 105° C. for 1 h 30 min. After this step, it was placed in a desiccator to cool and not acquire moisture in water. Then they were weighed again and the moisture value was determined by the formula:

$$\text{?} U = \frac{m \text{?} - m \text{?}}{m} \times 100$$

$$\text{?} \text{indicates text missing or illegible when filed}$$

The results of the analyzes are available in table 2.

TABLE 2
Composition

| | Humidity | Aluminum | Polyethylene | Others |
|---|---|---|---|---|
| Material | % | % | % | % |
| PolyAlu post-hydrapulper | 50 | 10 | 37 | 3 |
| PolyAlu post-pyrolysis | 2.0 | 23 | 0 | 75 |
| PolyAlu post- | 1.3 | 20 | 74 | 4.7 |
| cleaning process | | | | |
| Aluminum powder | — | 93.43 | — | 6.57 |
| post 3D printing | | | | |
| Flexible packaging | 0.8 | 22 | — | 77.2 |

### Characterization of PolyAlu Before Alkaline Dissolution

Fourier transform infrared spectroscopy (FTIR) analyzes and differential scanning calorimetry (DSC) analysis were performed to identify the type of polymer.

FTIR analysis was used to evaluate the functional groups present in the polymer. The FTIR result of PolyAlu before alkaline dissolution, FIG. 9, showed the characteristic bands of polyethylene, valence or “stretching” between 2950 and 2850 cm⁻¹; pendulum or “bending” between 1350 and 1450 cm⁻¹; twisting or “rocking” at approximately 700 cm⁻¹. It also presented additional bands of organic compounds. Such compounds could not be precisely defined. However, the bands can correspond to CO and CX bonds (X═F, Cl, Br, I), indicating fiber residual from the previous processing.

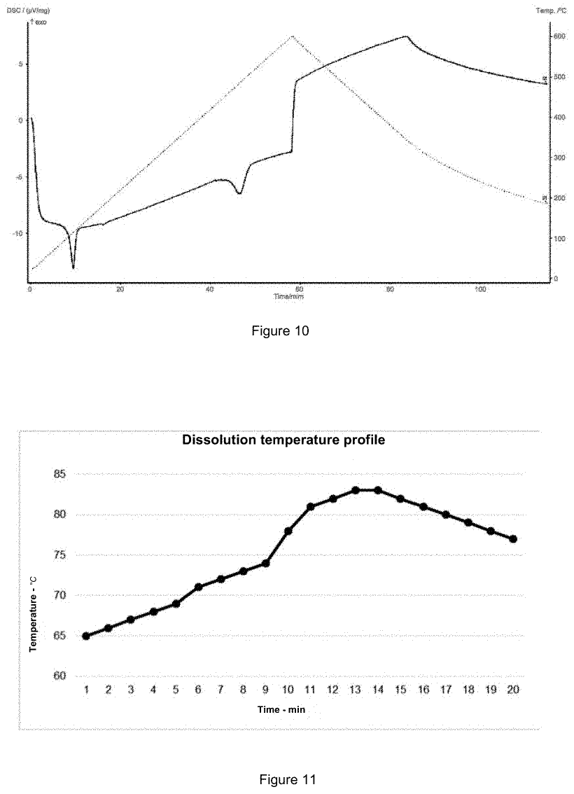

As for the DSC analysis, performed in an inert atmosphere with a purge gas flow of 50 ml/min argon and a protective gas flow of 100 ml/min argon, with temperatures from 25° C. to 600° C. at a heating rate of 10° C./min of a 2.79 mg sample of the polymer after the cleaning process, FIG. 10. Empty alumina crucibles were used as a reference.

In the DSC curve, two endothermic peaks were observed (the first around 115° C. and the second around 485° C.). Such peaks corroborate the FTIR-ATR analysis with the thermal properties of polyethylene, in which the first peak represents the melting temperature and the second the polymer degradation. In this case, the sample shows thermal behavior of low density polyethylene, which is commonly applied in the manufacture of films and packaging.

### Solubilization of Aluminum

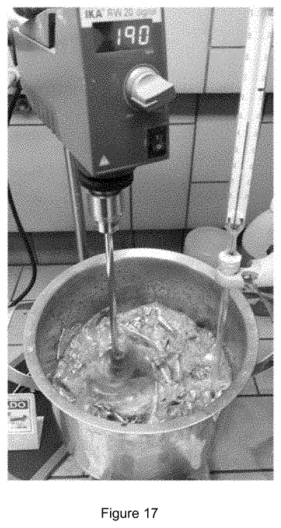

150 g of raw materials were weighed and transferred to a reactor containing 1 liter of Bayer liquor solution under a temperature of 65° C., with constant agitation, as shown in FIG. 17. The temperature was measured using a glass thermometer and the reaction time was measured. After the reaction was finished, filtration was performed with a 150 μm screen and the filtrate was collected for chemical composition analysis. The polyethylene retained on the filtration screen was washed with 500 mL of water, and then the material was taken to dry in an oven at 85° C. for 6 h. Finally the mass of polyethylene was weighed.

The results of the experiments are shown below:
1. PolyAlu Post-cleaning Process

The result of the aluminum dissolution temperature profile, shown in FIG. 11, was important to ensure temperature control and prevent loss of polymer properties.

Results of the analysis of Bayer liquor before and after the aluminum dissolution process contained in the PolyAlu sample after the cleaning process are shown in table 3.

TABLE 3
Analysis results of Bayer liquor before and after the process

| Total | Caustic | A1₂O₃ | Na₂CO₃ | NaC₂O₄ | NaC1 | NaF | Na₂SO₄ |
|---|---|---|---|---|---|---|---|
| Condition | (g/L) | (g/L) | (g/L) | (g/L) | (g/L) | (g/L) | (g/L) |
| Before | 228.3 | 100.2 | 74.6 | 4.59 | 6.56 | 0.81 | 3.98 |
| After | 226.2 | 151.2 | 73.6 | 4.52 | 6.24 | 0.90 | 3.87 |

2. Aluminum Powder after 3D Printing

Results of the analysis of Bayer liquor before and after the aluminum dissolution process contained in the aluminum powder sample are shown in table 4.

TABLE 4
Analysis results of Bayer liquor before and after the process

| | Total | | | | | | |
|---|---|---|---|---|---|---|---|
| | Caustic | A1₂O₃ | Na₂CO₃ | NaC₂O₄ | NaC1 | NaF | Na₂SO₄ |
| Condition | (g/L) | (g/L) | (g/L) | (g/L) | (g/L) | (g/L) | (g/L) |
| Before | 223.3 | 87.4 | 58.65 | 5.03 | 6.15 | 1.38 | 2.93 |
| After | 227.7 | 108.3 | 62.85 | 5.35 | 6.49 | 1.34 | 3.23 |

3. Flexible Packaging

Results of the analyses of the Bayer liqueur before and after the dissolution process of the aluminum contained in the sample of coffee packaging and juice packaging are shown in tables 5 and 6.

TABLE 5
Analysis results of Bayer liquor before
and after the coffee packaging process

| | | Caustic | |
|---|---|---|---|
| | Total | Al₂O₃ | Na₂CO₃ |
| Condition | (g/L) | (g/L) | (g/L) |
| Before | 214.6 | 99.7 | 66.8 |
| After | 217.5 | 114.6 | 67.3 |

TABLE 6
Analysis results of Bayer liquor before
and after the juice packaging process

| | | Caustic | |
|---|---|---|---|
| | Total | Al₂O₃ | Na₂CO₃ |
| Condition | (g/L) | (g/L) | (g/L) |
| Before | 214.6 | 99.7 | 66.8 |
| After | 216.4 | 134.2 | 67.8 |

4. Post-pyrolysis

Results of the analysis of Bayer liquor before and after the process of dissolving the aluminum contained in the pyrolysis sample are shown in table 7.

TABLE 7
Analysis results of Bayer liquor
before and after the process

| | | Caustic | |
|---|---|---|---|
| | Total | Al₂O₃ | Na₂CO₃ |
| Condition | (g/L) | (g/L) | (g/L) |
| Before | 214.6 | 99.7 | 66.8 |
| After | 218.7 | 187.4 | 70.5 |

### Calculation to Determine the Solubilization Efficiency

The efficiency of the solubilization process is achieved through the mass balance of the aluminum solubilized in the solution.

By the mass balance we have:

Aluminum mass in the sample:

$$Aluminum mass \text{?} ( g ) Wet mass \text{?} ( g ) \times [ 1 - ( \frac{\% Moisture \text{?}}{100} ) ] \times ( \frac{\% Aluminum \text{?}}{100} )$$

$$\text{?} \text{indicates text missing or illegible when filed}$$

$$Aluminum mass \text{?} ( g ) = 150 , 0 \times ( \frac{20}{100} ) \times [ 1 - ( \frac{1 , 3}{100} ) ] = 29 , 61 g$$

$$\text{?} \text{indicates text missing or illegible when filed}$$

Al₂O₃ equivalent in the Bayer solution:

$$Al 2 O 3 Mass ( g ) = Aluminum mass \text{?} ( g ) \times \frac{MM Al 2 O 3}{MM Al \times 2}$$

$$\text{?} \text{indicates text missing or illegible when filed}$$

$$Al 2 O 3 Mass ( g ) = \text{?} = 29 , 61 ( g ) \times \frac{102 \frac{g}{Mol}}{27 \frac{g}{mol} \times 2} = 55 , 93 g$$

$$\text{?} \text{indicates text missing or illegible when filed}$$

Maximum Al₂O₃ concentration in the Bayer solution after the dissolution process:

$$[ Al2 ( Bayer liquor after dissolution \text{?} Al203 Mass ( g ) g ) + [ Al203 Sol Bayer ] \\ [ Al2 ( Bayer liquor after dissolution \text{?} ▪ 55.93 ( g ) + 100.2 g \text{/} L ▪ 156.13 g \text{/} L \\ \text{?} \text{indicates text missing or illegible when filed}$$

Calculating the Efficiency of the aluminum dissolution reaction gives:

$$Efficiency ( \% ) \text{?} = \frac{post dissol \text{?} - \text{?} initial}{\text{?} max - \text{?} initial} \times 100$$

$$\text{?} \text{indicates text missing or illegible when filed}$$

$$Efficiency ( \% ) \text{?} = \frac{151 , 2 g \text{/} L - 100 , 2 g \text{/} L}{156 , 13 g \text{/} L - 100 , 2 g \text{/} L} \times 100 = 91 , 2 \%$$

$$\text{?} \text{indicates text missing or illegible when filed}$$

The results of the analysis of Bayer liquor before and after the aluminum dissolution process for all raw materials used show a significant increase in the concentration of alumina (Al₂O₃) in the solution, indicating that the aluminum dissolution was effective. Table 8 shows the data with the reaction efficiency calculation.

TABLE 8
Calculation of the reaction efficiency

| Material | Efficiency (%) |
|---|---|
| PolyAlu post-cleaning process | 91.2 |
| 3D printing post aluminum powder | 75.3 |
| Flexible packaging-coffee powder | 35.3 |
| Flexible packaging-juice packaging | 63.9 |
| Post-pyrolysis | 64.9 |

The efficiencies of the aluminum dissolution process can vary according to the reaction time, the concentration of raw material in the solution, the intensity of agitation, the particle size or even making new batches of dissolution with a new liquor.

### PolyAlu Filtration and Washing Process After Alkaline Dissolution

The material went through a washing process to remove the liquor and return to neutral pH. After washing, the material was dried in an oven at 85° C. for 6 hours.

### Characterization of PolyAlu After Alkaline Dissolution

To prove the recycling potential of the Polymer separated and washed after the dissolution of the aluminum a series of analyzes were carried out are presented in the sequence.

An analysis was performed on the polyethylene after drying, infrared spectroscopy with Fourier transform (FTIR). The results are shown in FIG. 12. The referring spectrum kept the characteristic bands of polyethylene, valence or “stretching” between 2950 and 2850 cm⁻¹; pendulum or “bending” between 1350 and 1450 cm⁻¹; twisting or rocking at approximately 700 cm⁻¹ and the residual bands of additional organic compounds were removed.

A DSC analysis was also carried out. The analysis was carried out in an inert atmosphere with a purge gas flow of 50 ml/min of argon and a protector of 100 ml/min of argon. Heating from 25° C. to 600° C. at a rate of 10° C./min of a sample of 3.24 mg of the polymer sample in an alumina crucible. Empty alumina crucibles were used as a reference.

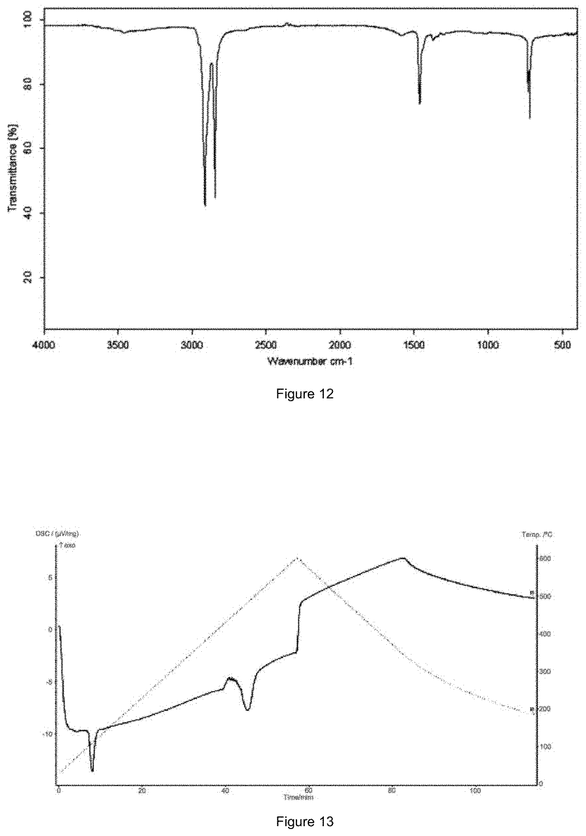

In the curve, FIG. 13, two endothermic peaks were observed (the first around 110° C. and the second around 480° C.). With the second showing a possible initial exothermic decomposition. Such peaks resemble the PolyAlu sample before alkaline dissolution, with the exception of this initially exothermic decomposition.

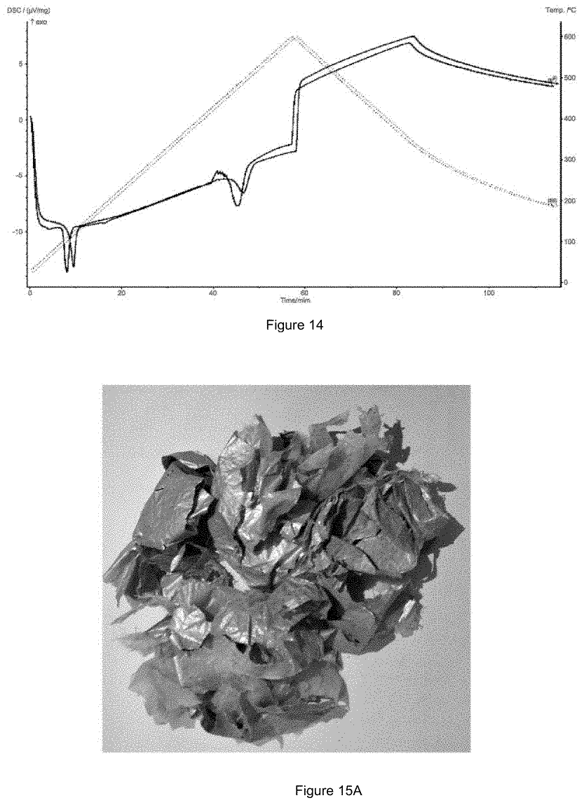

Superimposing the graphs, we have FIG. 14. It is observed that this possible initial exothermic decomposition is not significant when compared to the DSC curve of the initial sample. Which indicates that the material did not undergo chemical attacks with the dissolution.

### Polymer Tensile Test After Alkaline Dissolution Process and Fluidity Index

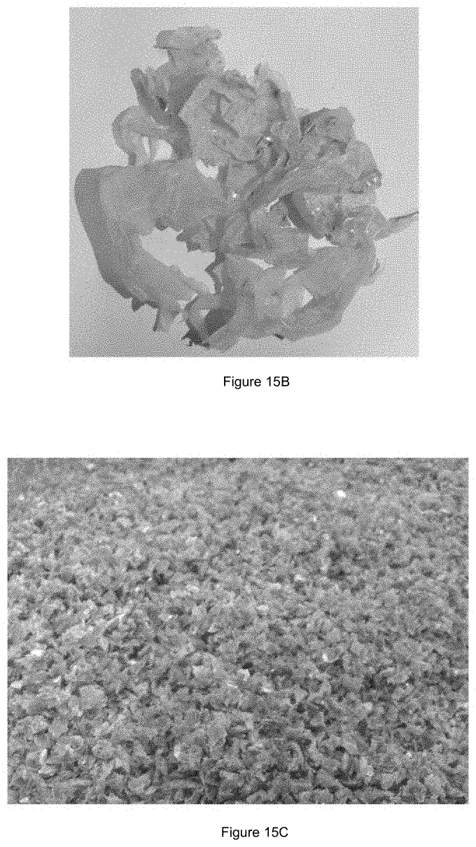

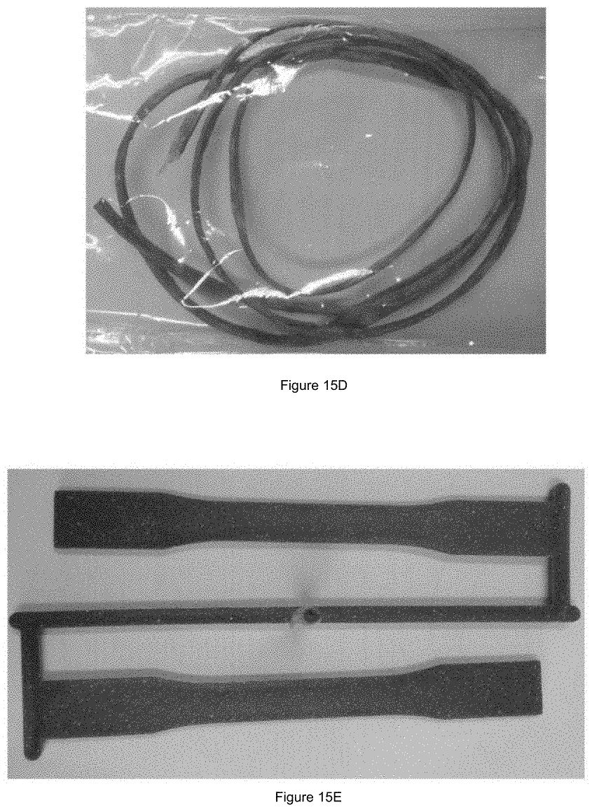

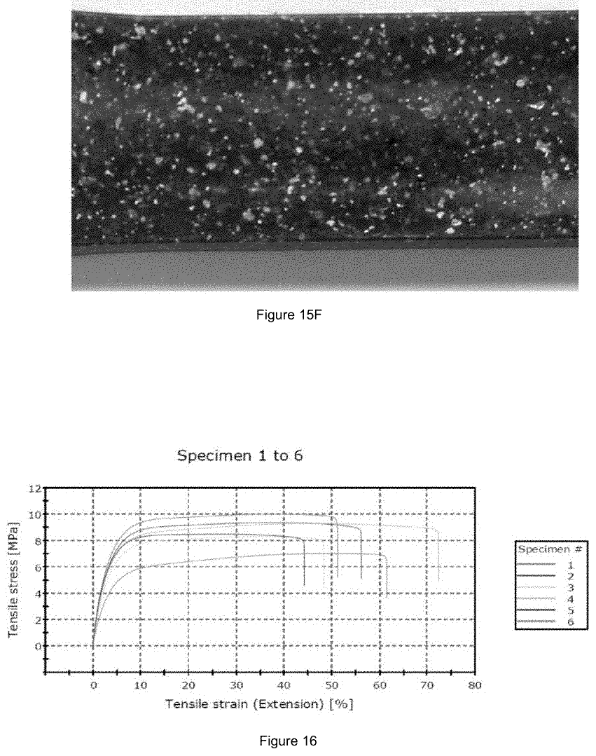

FIGS. 16A and 16B visually demonstrate the removal of aluminum after dissolution. To show the effectiveness of the dissolution recycling process, after this process the polymer that remained after the alkaline aluminum dissolution process was processed using pressing, melting and grinding techniques, as shown in FIG. 15C, and then extruded, FIG. 15D, and cut to form the pellets. To perform the tensile test, the pellets were inserted into an injection molding machine with a traction specimen mold, FIG. 15E, following the ASTM D638 standard specification. The tensile test was performed in a room with controlled humidity at 50%, temperature at 22.5° C. and stretching speed of 50 mm/min. In FIG. 15F it is possible to observe that there is still a small percentage of aluminum.

The graph in FIG. 16 shows the tests performed in the laboratory. Table 9 shows the results of the tensile tests.

TABLE 9
Comparison of tensile results of the post-dissolving polymer with the pure PE.

| | Breaking Stress (MPa) | | | | | |
|---|---|---|---|---|---|---|
| | Average Standard | | Deformation at break (%) | | Elastic Modulus (MPa) | |
| | deviation | | Average Standard deviationAverage | | Standard deviation | |
| Pure PE | 11.36 | 0.31 | 116.70 | 4.09 | 95.37 | 5.13 |
| PolyAlu | 10.97 | 0.12 | 38.86 | 3.51 | 177.60 | 2.23 |
| Post-dissolution | 8.90 | 1.05 | 53.19 | 10.67 | 343.05 | 30.92 |
| polymer | | | | | | |

The tensile strength has been reduced slightly when compared to pure PE and PolyAlu. When the deformation of the Polymer post-dissolution is compared with the deformation of pure PE, a reduction of this property is perceived, however it presents a greater value when compared to the deformation with that of PolyAlu. The increase in the elastic modulus is related to aluminum and the removal of residual fibers during the processes of this work.

The fluidity index (MFI) test was carried out with a load of 2.16 kg and a temperature of 190° C. The material was tested after injection. The result obtained was 6.672 g/10 min.

The flow rate of virgin polyethylene is 6.0 to 8.0 g/10 min. Which indicates that the material maintained this property.

### Reaction of Polyethylene with Bayer liquor

Polyethylene (PE) is stable in alkaline solutions. However, at high temperatures the PE structure becomes porous, making washing and separation difficult. Therefore, it is necessary to control the reaction temperature so that it does not reach temperatures above the PE degradation temperature. A maximum temperature of 85° C. was thus determined.

It is important to remember that the temperature control was made below 100° C. so that the polyethylene does not melt, since the melting temperature is in the region of 110° to 130° C., depending on the type of polyethylene.

### Mixture of Hydrogen

The blending of hydrogen with natural gas has already been studied by companies in Europe. For example, in England a consortium of companies, Cadent Gas and Northern Gaz Networks, with Keele University, are studying the possibility of blending hydrogen with the natural gas network to reduce the production of carbon produced.

The NREL laboratory, in the United States, also carried out a study of blending with natural gas, in small concentrations, of 5% -15%. For this, it is necessary to evaluate the costs, impacts and reductions. The Gastec group also conducted studies for companies in the Netherlands, Germany, Italy, England and the United States.

1. An aluminum recovery process, for recovering aluminum from a recycled material containing aluminum that comprises a raw material, such as aseptic carton packs, flexible packs, aluminum powders, or similar, the process comprising the steps of:
dissolving, via alkaline dissolution, the raw material containing aluminum in Bayer liquor, generating sodium aluminate and gaseous hydrogen; and
submitting the sodium aluminate to the Bayer process for the production of alumina and later aluminum.

2. The process according to claim 1, characterized by comprising the additional step of using the gaseous hydrogen produced, in the alkaline dissolution step, as a fuel in combustion units of the alumina refinery.

3. The process according to claim 1, characterized in that it additionally comprises the step of adding NaOH to correct the concentration of the sodium aluminate solution.

4. The process according to claim 3, characterized in that said alkaline dissolution comprises the reaction, in a reactor, of the raw material post treated with sodium aluminate corrected with caustic soda (NaOH), said caustic soda being added in a up to 50% by weight.

5. The process according to claim 1, characterized in that said Bayer liquor is added in concentrations of 100 g/l to 1,000 g/l, based on Na₂CO₃.

6. The process according to claim 1, characterized in that it comprises, after the alkaline dissolution step, the further step of performing a liquid/solid separation in order to separate the sodium aluminate (liquid) from the polymeric residue (solid).

7. The process according to claim 6, characterized in that the solid polymeric residues are subjected to a cleaning and subsequent recycling process.

8. The process according to claim 7, characterized in that the process for cleaning solid waste comprises washing the solid waste with water to eliminate residual sodium aluminate.

9. The process according to claim 7, characterized characterized in that the recycling process comprises the drying of solid waste and subsequent processing of the polymer, such as extrusion, pressing, injection, among others.

10. The process according to claim 1, characterized in that it further comprises a step of preparing the raw material, preceding the alkaline dissolution step.

11. The process according to claim 10, characterized in that, when the recycled material containing aluminum is obtained from aseptic carton packs, it comprises the steps of:
remove the paper, preferably via a hydrapulper, generating a laminated aluminum and polymer by-product (PolyAlu); and
process the by-product (PolyAlu), from:
a cleaning procedure, to generate a raw material suitable for the alkaline dissolution step;
or
a pyrolysis process followed by a coal removal process, to generate a raw material suitable for the alkaline dissolution step; or
a chemical separation process, to generate a raw material suitable for the alkaline dissolution step.

12. The process according to claim 10, characterized in that, when the recycled material containing aluminum is obtained from aseptic carton packs, it comprises the steps of:
subjecting flexible packaging to a pyrolysis process followed by a process of removing coal, to generate a raw material suitable for the alkaline dissolution step; or
grind the flexible packaging, or the flexible packaging shavings, to generate a raw material suitable for the alkaline dissolution step.

13. The process according to claim 10, characterized in that, when the recycled aluminum-containing material is aluminum powder from 3D printers, it directly proceeds to alkaline dissolution.

14. The process according to claim 10, characterized in that the alkaline dissolution employs one, or a combination, between the raw materials.

15. The process according to claim 11, characterized in that the alkaline dissolution employs one, or a combination, between the raw materials.

16. The process according to claim 12, characterized in that the alkaline dissolution employs one, or a combination, between the raw materials.

17. The process according to claim 13, characterized in that the alkaline dissolution employs one, or a combination, between the raw materials.
